(19) United States
(12) Patent Application Publication
(10) Pub. No.: US 2025/0065328 A1
(43) Pub. Date: Feb. 27, 2025

(54) ANALYSIS CARD FOR ANALYSING A BIOLOGICAL SAMPLE, AND PRODUCTION AND QUALITY CONTROL METHOD

(71) Applicant: BIOMERIEUX, Marcy L'Etoile (FR)

(72) Inventors: Patrick BROYER, Saint-Cassien (FR); Jérôme BLAZE, Grenoble (FR); Frédéric PINSTON, Grenoble (FR); Matthieu GOUJARD, Grenoble (FR)

(73) Assignee: BIOMERIEUX, Marcy L'Etoile (FR)

(21) Appl. No.: 18/724,944

(22) PCT Filed: Dec. 28, 2022
(86) PCT No.: PCT/FR2022/052515

§ 371 Date: Jun. 27, 2024

(30) Foreign Application Priority Data
Dec. 31, 2021 (FR) FR2114728

(51) Int. Cl. B01L 3/00

(52) U.S. Cl. CPC B01L 3/502715; B01L 2200/143; B01L 2200/16; B01L 2300/0663; B01L 2300/0816; B01L 2300/0864

(57) ABSTRACT

An analysis card for analysing a biological sample by means of an in-vitro diagnostic instrument, the analysis card including a plurality of wells formed in a board, each well containing at least one reagent, the analysis card including a channel for conveying a liquid sample to the wells, characterised in that each well forms, in the board, an internal space defined by a lateral surface, the lateral surface including at least one wall, and in that each well has the at least one reagent deposited only on its lateral surface.

### TECHNICAL FIELD

The present invention relates to the field of analysis of biological samples, and more specifically relates to an analysis card for the analysis of a biological sample, in particular for the detection of endotoxins, using an in vitro diagnostics instrument, and to the methods for production of the analysis card and for quality control of a plate of an analysis card.

### TECHNOLOGY BACKGROUND

The analysis of a biological sample, such as for example endotoxin detection tests, is based on one or more reactions between the biological sample and one or a plurality of reagents. There are microfluidic systems and methods for carrying out these biological sample analyses. The reagents are deposited in wells and the biological sample is, for example, introduced via a supply channel. This requires the preparation of multiple standard dilutions and internal controls. In the context of endotoxin detection, for example, the tests are demanding and require many steps of handling by the operator. These manual preparation steps are time-consuming and can produce variable or even invalid results. In addition, there is no solution for monitoring the preparation of the tests and thus quickly determining whether an error has been made. Thus, it is only at the end of a period of measurement, when an attempt is made to exploit the erroneous results, that any problems can be detected, this period being selected beforehand to be long enough to allow full completion of the various reactions likely to occur with different dynamics.

There are microplates such as the “GOPLATE™” system comprising 96 wells pre-filled with required standard quantities of reagents, the concentrations of which have been checked. This device reduces the handling time by more than 50% compared to conventional microplate endotoxin tests. However, performing biological sample analysis using this device requires numerous additional accessories and still involves multiple manual steps. There are also microplates integrated into consumable systems such as the “FilmArray®”, which require few manual operations. These pre-filled microplates also make it possible to limit human intervention in the biological sample analysis process and therefore to reduce the risk of human error.

However, the prefilled microplates found in the prior art are not suitable for certain reactions requiring the use of different reagents which must not react with one another and therefore must not be mixed before a biological sample is introduced into the wells of the microplate. Furthermore, in the prior art, a reagent is most often deposited at the bottom of the wells of the microplates. This requires a multiplicity of steps including, among others, depositing reagents on a film adhesively bonded to one of the faces of the microplate serving as a bottom for the wells, applying double-sided adhesive films to each of the faces of the microplate and then inserting the plate between two films of an analysis bag. These different layers of plastic films contribute to increasing the cost of the consumable, and complicate production thereof.

There is therefore no solution making it possible to deposit adjacent drops (<1 μL) without contact between the drops during drying in a miniature microplate which does not previously include a deposit support perpendicular to the axis of deposition of the reagent.

### PRESENTATION OF THE INVENTION

The invention therefore aims to make it possible to analyse a biological sample, in particular for the detection of endotoxins, in a more reliable, rapid and less expensive manner.

For this purpose, the invention proposes an analysis card for analysing a biological sample by means of an in vitro diagnostics instrument, the analysis card comprising a plurality of wells formed in a plate, wells containing at least one reagent, the analysis card comprising a supply channel for supplying a liquid sample to the well,

characterized in that each well forms in said plate an internal space defined by a lateral surface, said lateral surface comprising at least one wall, and in that the reagent in a well is deposited and dried only on the lateral surface of said well.

The invention is advantageously supplemented by the various features below, which may be implemented alone or in their various possible combinations:

Each well passes through the plate from one face to another face of said plate.

Each well has several different reagents deposited, preferably only, on its lateral surface, said different reagents comprising a first reagent and a second reagent.

The first reagent is capable of being activated by the second reagent and then reacting with the liquid sample.

Each well includes a plurality of lobes and a plurality of junctions connecting the lobes.

Each well has several different reagents deposited only on its lateral surface, said different reagents comprising a first reagent and a second reagent, and a well contains at least the first reagent deposited on a wall of a first lobe of said well and the second reagent deposited on a wall of a second lobe of said well.

The lobes of a well have an elliptical shape and the junctions of a well are rectilinear in a junction direction.

A junction connects only two lobes of a well and all of the lobes and junctions of a well form an open chain.

The analysis card is associated with an analysis orientation imposed on the analysis card during the analysis of the biological sample by means of the in vitro diagnostics instrument, this analysis orientation being characterized in that the faces of the plate extend in the predetermined direction, preferably a vertical direction, and a first lobe of a well is connected to a second lobe of said well by a junction in a junction direction and the angle between the predetermined direction and said junction direction is preferably greater than 10°.

The diameter of the lobes of the wells is greater than 0.1 mm, the width of the junctions is less than 1 mm, and the length of the junctions is greater than 0.05 mm.

Each face of the plate is covered with a transparent film at least on a face intended to allow analysis of the analysis card.

The analysis reagents are adapted to cause a luminescence reaction in the presence of endotoxins.

The invention also relates to a method for the production of an analysis card, comprising the following steps:
a) supplying a plate provided with a plurality of wells,
b) positioning the plate in an analysis orientation in which the faces of the plate extend in the predetermined direction,
c) depositing at least one drop of reagent liquid in contact with lateral surface of the well,
d) drying the at least one drop of reagent and obtaining reagent deposited on the wall of the lateral surface of the well.

This production method is advantageously supplemented by the various features below, which may be implemented alone or in their various possible combinations:

The production method comprises a step e) of inserting the plate between two films, and adhesion of the films to the plate.

Step c) of depositing the drop of reagent comprises steps of:
c1) placing a needle with one end of the needle in the internal space of a well,
c2) forming a drop at the end of the needle, until contact is made with a wall of the lateral surface,
c3) withdrawing the needle.

The invention also relates to a method for quality control of a plate provided with a plurality of wells, each well forming in said plate an internal space defined by a lateral surface, wells having a plurality of deposits of liquid reagents deposited separately on the lateral surface thereof, comprising steps of:
Q1) acquisition of an image of said plate,
Q2) verification of the absence of liquid between deposits of liquid reagent.

This quality control method is advantageously supplemented by the various features below, which may be implemented alone or in their various possible combinations:

The quality control method comprises a step Q0) of acquisition of an image of said empty plate, and step Q2) comprises the comparison of pixels of the image acquired in step Q1) and of pixels of the image acquired in step Q0).

The image of the plate is a shadowgraphy image.

The quality control method comprises a step a1) of recognition by an algorithm for detecting the wells of the plate and identification of regions of interest for each well of the plate for which the absence of liquid is verified.

Each well comprises a plurality of lobes and a plurality of junctions connecting the lobes, the lobes being intended to receive the deposits of liquid reagents, and the regions of interest include the junctions, the absence of liquid in said junctions being verified.

### PRESENTATION OF THE FIGURES

Other features, aims and advantages of the invention will become apparent from the following description, which is purely illustrative and non-limiting, and which must be read with reference to the appended drawings, in which:

FIG. 1 shows an example analysis card;

FIG. 2 schematically depicts a well of the analysis card according to a possible embodiment of the invention;

FIG. 3 schematically depicts a well of the analysis card comprising three lobes according to a possible embodiment of the invention;

FIG. 4 schematically depicts an analysis card arranged in an analysis orientation, the analysis card comprising wells with three lobes according to a possible embodiment of the invention;

FIG. 5 is a diagram showing steps of the method for the production of the analysis card according to a possible embodiment of the invention;

FIG. 6a depicts two needles positioned just inside the internal space of a well;

FIG. 6b depicts the formation of two drops of reagent at the end of the needles;

FIG. 6c depicts the deposition of two drops of reagent on the lateral surface of the lobes of the same reaction well;

FIG. 6d depicts two needles withdrawn from the internal space of a well after depositing two drops of reagent on the lateral surface of the lobes of the same reaction well;

FIG. 7 is a diagram showing steps of the method for quality control of a plate having a plurality of wells according to a possible embodiment of the invention;

FIG. 8 is a diagram of the control system;

FIG. 9 shows the plate of the analysis card, after the deposition of drops of reagent;

FIG. 10 is an image acquired in step Q0 of the control method according to the invention;

FIG. 11 is an image acquired in step Q1 of the control method according to the invention;

FIG. 12a is an image showing the algorithmic identification of regions of interest of the lobes for each well, where the presence of liquid will be verified;

FIG. 12b is an image showing the algorithmic identification of regions of interest of the junctions for each well, where the presence of liquid in these junctions will be verified;

FIG. 13 shows the extraction of the regions of interest of the lobes and the algorithmic verification of the presence of liquid;

FIG. 14 shows the extraction of the regions of interest of the junctions and the algorithmic verification of the presence of liquid.

### DETAILED DESCRIPTION

### Analysis Card

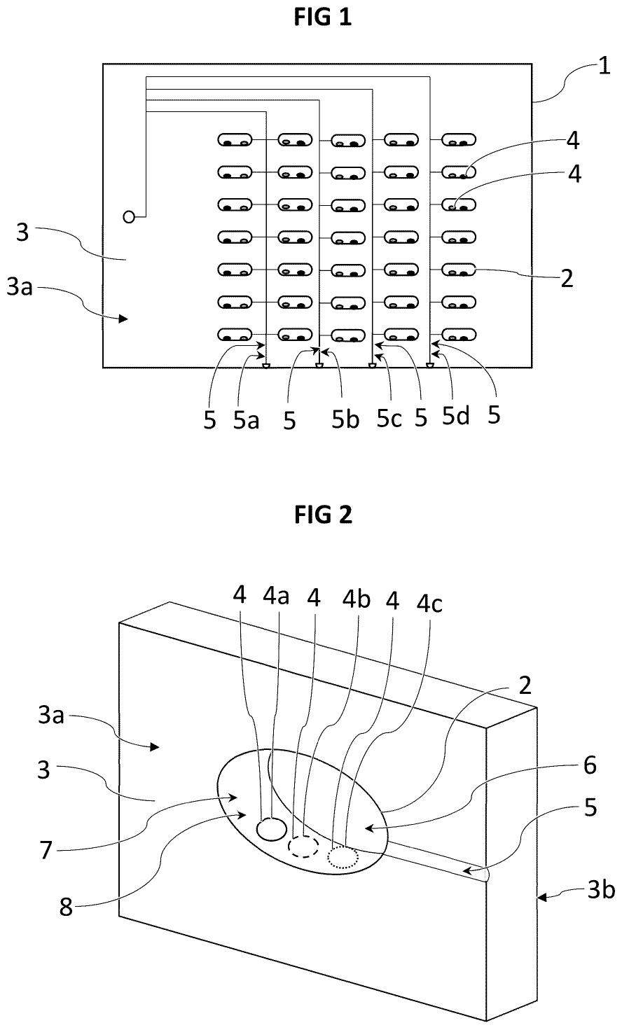

With reference to FIG. 1, the analysis card 1 comprises a plurality of wells 2 which may be used to put in place one or more reagents 4. Typically, an analysis card comprises more than twenty wells 2. In the example illustrated, the analysis card 1 includes thirty-five wells 2. The wells 2 are formed in a plate 3 and each well 2 passes through the plate 3 from a first face 3a to a second face 3b opposite the first face 3a. A plate 3 is generally defined as an element with a flat, thin surface. In other words, a plate 3 comprises at least two flat faces 3a, 3b opposite one another and separated by a small thickness, i.e. the thickness is at least 10 times smaller than the widths and lengths of the faces 3a, 3b. The lengths and widths of the faces 3a, 3b of the plate 3 of the analysis card 1 are preferably greater than 2 cm, and preferably less than 10 cm. The thickness of the plate 3 is preferably less than 5 mm, more preferably less than 3 mm, and the thickness of the plate 3 is preferably greater than 1 mm. Preferably, the thickness of the plate 3 is constant over the analysis card 1, except in the presence of a well 2 or other functional elements which form a hollow in the plate 3.

The plate 3 may be made of materials such as Polypropylene, Polyethylene, Polystyrene, Polycarbonate, PMMA, COP, POM, ABS, for example, or any thermoplastics that may be manufactured by injection molding. Preferably, the wells 2 are regularly distributed over the faces 3a, 3b of the plate 3, forming a grid, and for example may be aligned in various rows and columns, in this case for example five columns in the widthwise direction of the plate 3 and seven rows in the lengthwise direction of the plate 3. An angular distribution of the reaction wells is also possible. The analysis card 1 also includes supply channels 5a to 5d configured to supply the wells 2 with a liquid biological sample or with another liquid such as a reference fluid used for example for control wells, in order to fill the wells 2 with liquid.

Each well 2 has at least one reagent 4. At least some reagents 4 are capable of causing a luminescence reaction in the presence of analytes, and in particular in the presence of endotoxins. The analysis card 1 may thus be used to detect the presence of endotoxins in the biological sample. Even though the invention concerns more specifically the analysis of biological samples to detect the possible presence of endotoxins, it may relate to the analysis of biological samples to detect other analytes such as for example assay of analytes in biochemistry or immunology, assay of quantity of RNA or DNA in molecular biology, detection of the presence of microorganisms in microvolumes, antibiogram analysis in microvolumes, detection and quantification of microorganisms for agri-food, cosmetic, pharmaceutical or veterinary applications.

With reference to FIG. 2, each well 2 forms in the plate 3 an internal space 6 defined by a lateral surface 7. The lateral surface 7 extends from the first face 3a to the second face 3b, along the well 2. The lateral surface 7 forms the interface between the material of the plate 3 and the internal space 6. The lateral surface 7 comprises at least one wall 8. In the case illustrated in FIG. 2, the internal space 6 is of oval cross section, and the lateral surface 7 therefore comprises a single wall 8. A lateral surface 7 may also be made up of several walls 8 as will be shown below in another embodiment. These walls 8 are encountered successively when crossing the lateral surface 7. A wall 8 is therefore defined as a part of a lateral surface 7. If the lateral surface 7 comprises several walls 8, these walls 8 are separated from the other walls 8 by edges. An edge is a line of intersection between two walls 8 and marks a discontinuity. For example, the edge marks an angular discontinuity or discontinuity of shape. For example, the edge may mark the intersection between a circular wall 8 and a rectilinear wall 8. Or, for example, the edge may mark the intersection between two adjoining circular walls 8, in which case it is possible to imagine an internal space in the shape of an empty number 8, and therefore a lateral surface 7 in the shape of a ribbon forming a figure eight.

Each well 2 has at least one reagent 4a, 4b or 4c deposited on its lateral surface 7. Preferably, once deposited the reagent 4 is dry (dehydrated) and is therefore not in liquid form. A reagent 4 thus forms a deposit of dry matter on the lateral surface 7. An analysis card 1 in which the reagents 4 are deposited on the lateral surface 7 of the wells 2 has several advantages. First of all, this makes it possible to better control the position of the reagents 4 in each well 2. To be specific, the reagents 4 are more precisely located on the lateral surface 7 of the wells 2 compared to reagents deposited in the bottom of the wells 2 which would have a certain propensity to spread because there is then no angular wall allowing the drops of reagents to be held in place by capillary action. Thus, it is possible to position the reagents 4 in such a way as to ensure interaction between reagents 4 and biological sample even in the presence of air bubbles, for example by positioning the reagents 4 in a location on the lateral surface 7 opposite to the direction of propagation of the air bubbles. Furthermore, this better control of the position of the reagents 4 means better interaction between the biological sample and the reagent 4 since the reagent 4 is concentrated on part of the lateral surface 7 of a well 2. Furthermore, as the position of a reagent 4 on the lateral surface 7 of a well 2 is known, it is possible to know whether the biological sample has been in contact with the reagent 4 by checking where the biological sample is positioned in the well 2.

Lastly, in the case where several reagents 4 are present in each well 2, the fact that the reagents 4 are deposited on the lateral surface 7 of the wells 2 makes it possible to avoid mixing between the reagents 4. To be specific, if the reagents 4 in the same well are deposited on the bottom of the well 2, the reagents 4 can spread until they come into contact during the deposition operation or during the drying period before complete dehydration, whereas depositing on the lateral surface 7 of the well 2 can prevent this. First of all, the lateral surface 7 of the well 2 has a much greater length than the diameter (longest length) of the bottom of a well 2, making it possible to space the reagents much further apart from one another. This aspect is all the more important as the reagents 4 are generally deposited in the form of drops of liquid before being dried, and these drops tend to spread out, with the risk of them mixing if they are too close. The separation of the reagents is all the more effective when two reagents 4 are deposited on two different walls 8 of the same lateral surface. Let us take as an example a well 2 with a lateral surface 7 made up of two communicating circular walls 8, a first wall 8 and a second wall 8, such that the internal space 6 has the shape of the number 8. If a first reagent 4 is deposited in the form of a drop (before drying) on the first wall 8 and a second reagent 4 is deposited in the form of a drop (before drying) on the second wall 8, the drops of reagents 4 will not mix, being separated by an edge delimiting the two walls 8. Conversely, if the reagents were placed at the bottom of the well 2, they would be closer, not separated by an edge, and would therefore probably mix.

The fact that the reagent 4 is deposited on the lateral surface 7 of a well 2 also means that each well 2 of the plate 3 does not require a bottom upon deposition of the reagent 4 in each well 2 of the analysis card 1. This firstly does away with a significant constraint as regards the respective arrangement in terms of depth of the analysis card 1 and the tool used for deposition. It also facilitates quality control of a plate 3 filled with reagents 4 by shadowgraphy, as will be described below, since there is no layer to prevent the passage of light rays into the empty spaces of the internal space 6 of the well 2. A plate 3 of an analysis card 1 without a bottom also allows a reduction in costs since the analysis card 1 may be directly inserted between two transparent films. Advantageously, to protect the reagents 4 in the wells 2, each face 3a, 3b of the plate 3 of the analysis card 1 is covered with a transparent film on each face or inserted in a consumable already comprising the two films after deposition and drying of the reagents 4 in the wells 2. In conclusion, the presence of reagents 4 on a lateral surface 7 of the wells 2 significantly simplifies the method for the production of the analysis card 1 and the cost of the analysis card 1.

In an alternative embodiment that has not been shown, it is possible to deposit the reagent on the lateral surface of a well even though the plate is provided with a bottom. In this case, the tool used for deposition is partially inserted into the well 2 without touching the bottom and the reagent is deposited only on the lateral surface of the well; it is possible, depending on the viscosity of the deposit, that the reagent will touch the bottom of the plate but only to a negligible extent. Advantageously, the bottom of the plate may be opaque or transparent. When the bottom is opaque, the luminescence analysis is carried out on the face of the analysis card opposite that on which the bottom of the plate is positioned. The rest of the features described above regarding the plate or the analysis card remain unchanged for this alternative embodiment, only the feature whereby the plate is provided with a bottom differs from the other embodiments described, and the deposition method is identical.

According to a certain embodiment, each well 2 has several different reagents 4 deposited only on its lateral surface 7, said different reagents 4 comprising a first reagent 4a, 4b, 4c and a second reagent 4a, 4b, 4c. The reagents 4 are not in contact and therefore did not mix when they were in liquid form, before being dried. The reagents 4 are dried to ensure that they will not mix so as to avoid inadvertently triggering the reaction between the different reagents before use of the consumable employing this plate 3. The reagents 4 in a well 2 must not be mixed so that they do not react together before a biological sample has been brought into the well 2 via the supply channel 5. To be specific, in order to analyse the biological sample, it may be necessary for a cascade reaction to take place and for the reagents 4 present in each well 2 not to have reacted with one another previously. For example, in the case of endotoxin detection, wells 2 may contain three different reagents 4a, 4b, 4c: a detection agent 4a in a non-active state in the absence of endotoxin-free activation, an activation agent 4b for activating the detection agent comprising an enzyme and a fluorogenic substrate, and a control reagent 4c adapted to control the functionality of the detection reagent. In this example, the detection and activation agents must not react with one another prior to the introduction of a liquid biological sample via the supply channel 5. The reagents 4a, 4b, 4c are therefore brought into contact only when a liquid biological sample is introduced into the well 2.

The geometry of the wells 2 is adapted to avoid mixing of the reagents 4a, 4b and 4c before the introduction of the reference liquid. First of all, if the lateral surface 7 of a well 2 comprises a single wall 8, the well 2 may be wide enough, and therefore the lateral surface 7 long enough, to allow a separation space between each reagent 4 deposited on the wall 8. For example, in FIG. 2, which depicts a well 2 the lateral surface 7 of which comprises a single wall 8, the well 2 is wide enough to leave a space between the reagents 4a, 4b, 4c on the lateral surface 7 which ensures separation of the reagents 4a, 4b, 4c. Furthermore, the lateral surface 7 of the wells 2 may have a shape which allows separation between each reagent 4a, 4b, 4c, by including a discontinuity such as an edge between two reagents 4a, 4b, 4c. The lateral surface 7 may comprise several walls 8 as explained above and the discontinuity between the walls 8 of the same lateral surface 7 allows a separation space between reagents 4a, 4b, 4c and even a border between them. It is possible to imagine a well 2 with an internal space 6 comprising three rounds, one of which communicates with the other two rounds. The lateral surface 7 comprises three successive rounded walls 8 across the lateral surface 7, with a discontinuity when going from one round to another, and therefore from one wall 8 to another. Each reagent 4a, 4b, 4c may be placed respectively on one of the three walls 8 of the lateral surface 7 such that each reagent 4a, 4b, 4c is placed on a different wall 8, and therefore inside a distinct part of the internal space 6 constituted by a round. The reagents 4a, 4b, 4c are therefore separated from one another within the same well 2.

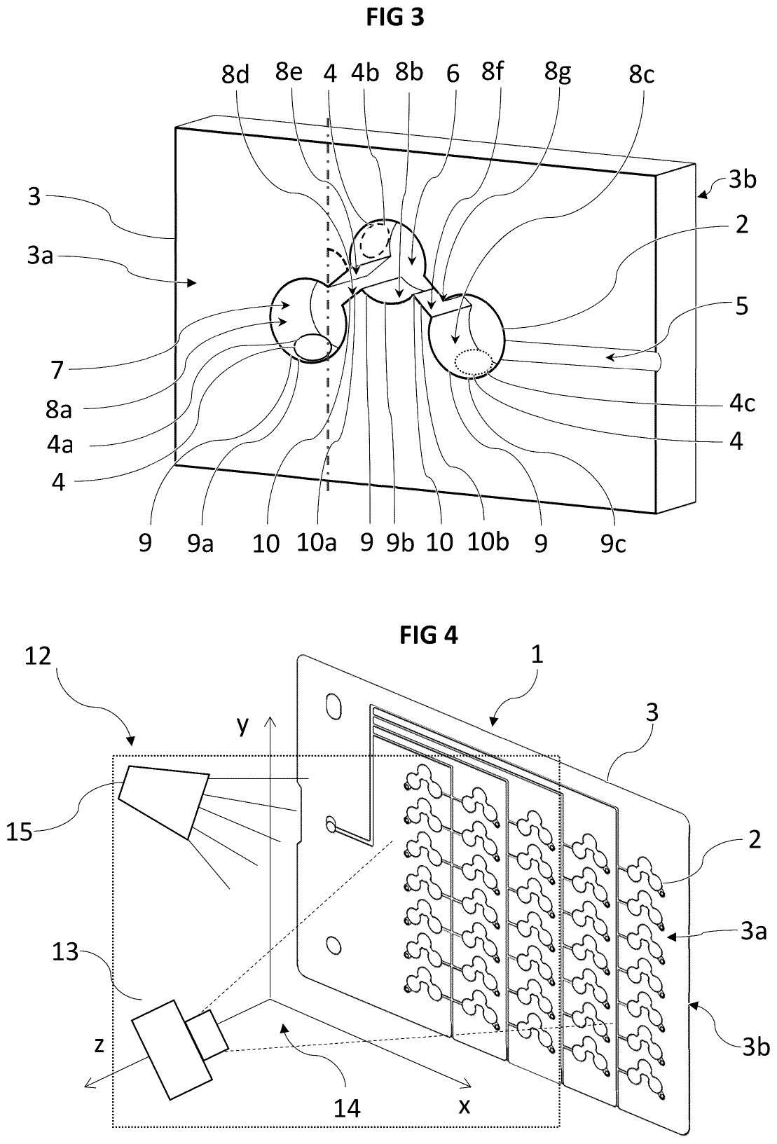

According to a preferred embodiment, as illustrated on the plate 3 portion in FIG. 3, each well 2 comprises a plurality of lobes 9, such as for example three lobes 9a, 9b, 9c, and a plurality of junctions 10, such as for example two junctions 10a, 10b, connecting the lobes 9a, 9b, 9c. In other words, each well 2 includes several distinct locations, referred to as lobes 9, which are in communication with one another via junctions 10. In this embodiment, the lateral surface 7 comprises several walls 8a, 8b, 8c, 8d, 8e, 8f, 8g, each wall 8 being associated with a lobe 9a, 9b, 9c or with a junction 10a, 10b, 10c.

Preferably, each lobe 9 is provided with a different reagent 4. Each well 2 has several different reagents 4 deposited only on its lateral surface 7, said different reagents 4 comprising, in the example illustrated in FIG. 3, a first reagent 4a and a second reagent 4b. The first reagent 4a is deposited on the wall 8a of a first lobe 9a of said well 2 and the second reagent 4b is deposited on the wall 8b of a second lobe 9b of said well 2. In the example illustrated in FIG. 3, a third reagent 4c is deposited on a wall 8c of a third lobe 9c. In an embodiment suitable for the detection of endotoxins, each well 2 comprises three lobes 9a, 9b and 9c and two junctions 10a and 10b, the wall 8a of a first lobe 9a having a detection agent 4a, the wall 8b of a second lobe 9b having an activation agent 4b and the wall 8c of a third lobe 9c having a control reagent 4c. Advantageously, the reagents 4a, 4b, 4c are only deposited on the walls 8a, 8b, 8c of the lobes 9 and there is no reagent 4 on the walls 8d to 8g of the junctions 10. This is because if a reagent 4 is present on a wall 8d-8g of a junction 10, this may mean that it will come into contact with another reagent 4 placed in a lobe 9, which is not desired. Furthermore, as stated, the reagents 4, once deposited, are preferably dry and not in liquid form.

Preferably, the lobes 9 of each well 2 have an elliptical shape and the junctions 10 of each well 2 are rectilinear in a junction direction. Even more preferably, the lobes 9 of each well 2 have a circular shape. Thus, and as shown, the walls 8a, 8b, 8c of a lobe 9a, 9b, 9c are typically rounded or curved, whereas the walls 8d, 8e, 8f, 8g of a junction 10a, 10b, 10c are flat.

The analysis card 1 is a microfluidic system. The diameter of the lobes 9 is preferably less than 3 mm and is preferably greater than 0.1 mm. The width of the junctions 10 is preferably less than 1 mm, and is preferably greater than 0.05 mm. The length of the junctions 10 is preferably less than 5 mm, and is preferably greater than 0.05 mm. These dimensions are both large enough to allow the circulation of a liquid such as the biological sample, and small enough so that the surface tension effects of a liquid make it possible to contain drops outside of the junctions 10 and also promote mixing of the reagents 4 once the sample has been introduced to take up the dried reagents 4 and trigger the analysis reaction.

As explained, this structure composed of lobes 9 and junctions 10 makes it possible to isolate the different reagents 4 to prevent them from mixing before drying. Still with the aim of preventing mixing of the reagents 4 as far as possible, the lobes 9 of each well 2 are preferably arranged in a particular way in relation to one another in order to optimize the surface area to be imaged. An analysis orientation is imposed on the analysis card 1 during the analysis of the biological sample by means of the in vitro diagnostics instrument 12. With reference to FIG. 4, the analysis orientation corresponds to a vertical orientation of the analysis card 1, in which the analysis card 1 is arranged when it is analysed by means of an in vitro diagnostics instrument 12 comprising an imager 13, typically a fluorimeter, defining a field of view 14. On the other hand, this orientation, referred to as vertical, is purely indicative and used as an example, and there is no technical link between the orientation of the card and the analysis per se. When the analysis card 1 is analysed, the analysis card 1 is placed in the in vitro diagnostics instrument 12 in this analysis orientation, in the field of view 14 of the imager 13. The in vitro diagnostics instrument 12 may also include a light source 15 configured to illuminate the field of view 14 with light having a wavelength capable of revealing fluorescence, that is to say causing the emission of fluorescent light after excitation of a fluorophore.

The analysis orientation of the analysis card 1 preferably corresponds to that in which the analysis card 1 is arranged in FIG. 4. The axis y corresponds to the vertical direction and the axis x corresponds to the horizontal direction. FIG. 4 depicts an analysis card 1 according to a certain embodiment, comprising a plurality of wells 2 with several lobes 9, in this case three lobes 9. In this instance, the analysis orientation of the analysis card 1 is that in which the axis of each cylinder defined by each lobe 9 is perpendicular to the vertical direction. Thus, returning to the relative arrangement of the lobes 9 of the same well 2, when the analysis card 1 is arranged in the analysis orientation, the angle between the vertical direction and the junction direction of the junction 10 between two lobes 9 of a well 2 is preferably greater than 10°, and is preferably less than 180° C. (or 0° C.). The vertical direction and the angle between the vertical direction and the direction of a junction 10 are shown in dotted lines in FIG. 3. Furthermore, this is made possible by the fact that the reagents 4 are deposited on the lateral surface 7 of each well 2. Indeed, returning to the example of endotoxin detection, the reagents 4 used have high wettability (contact angle between 75° and 90°). Consequently, if drops of reagents 4 were deposited on a bottom of the lobes 9 of a well 2, they would be very likely to move and spread in such a way as to mix with one another before drying, something which is not desired. Thus, the structure imposed by the different lobes 9 of a well 2 and the fact that the reagents are deposited on the lateral surface 7 of each well 2 guarantees as best as possible the isolation of the reagents 4 deposited in different lobes 9 relative to one another.

In order to allow a coherent cascade reaction and to prevent mixing between the various reagents 4 in a well 2, each junction 10 connects only two lobes 9 of a well 2 and all of the lobes 9 and junctions 10 of a well 2 form an open chain. A coherent cascade reaction means a reaction in which the order in which the sub-reactions of the reaction take place corresponds to the optimal order for obtaining exploitable results. In other words, in the context of a reaction involving several sub-reactions and therefore several reagents 4, it may be necessary for a certain reagent 4 to react with the biological sample before reacting with another reagent 4. In the example of endotoxin detection, it is preferable for the biological sample to come into contact with the activation agent 4b before coming into contact with the detection agent 4a. Thus, the open chain formed by all of the lobes 9 and junctions 10 of a well 2 makes it possible to manage the order in which the sub-reactions of a cascade reaction will take place. The term “open chain” describing all of the lobes 9 and junctions 10 means that two lobes 9 out of all of the lobes 9 are each connected to a single junction 10. These two lobes 9 are in fact the first lobe 9 and the last lobe 9 of the chain, in other words, these two lobes 9 constitute the ends of the chain. Obviously, one of the lobes 9 located at one end may also, in addition to being connected to a single junction 10, be connected to a supply channel 5.

### Analysis Card Production Method

The invention also relates to the method for the production of the analysis card 1. This method is presented in FIG. 5. In step a), a plate 3 having a plurality of wells 2, which preferably pass right through said plate 3, is provided. “Provided” means that the production method requires the availability of a plate 3 comprising a plurality of wells 2, the wells 2 being preferably empty of any reagent 4.

The present method may also include a prior step a0) of plastic injection molding of the plate 3.

In a step b), the plate 3 is placed in an analysis orientation. In this example, the analysis orientation corresponds to the orientation in which the faces 3a, 3b of the plate 3 are vertical.

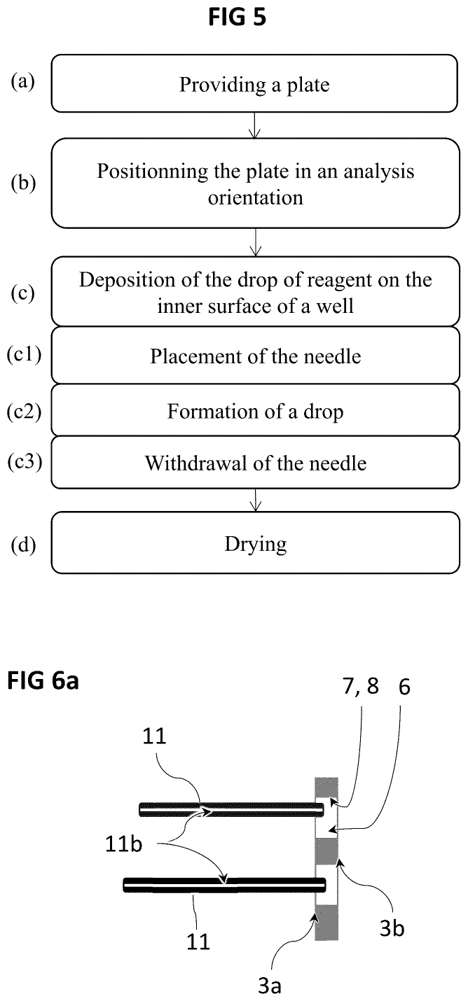

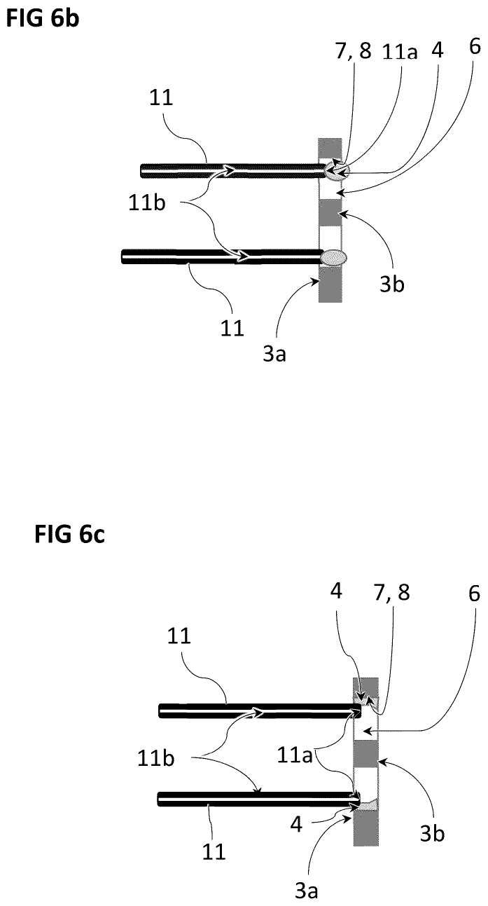

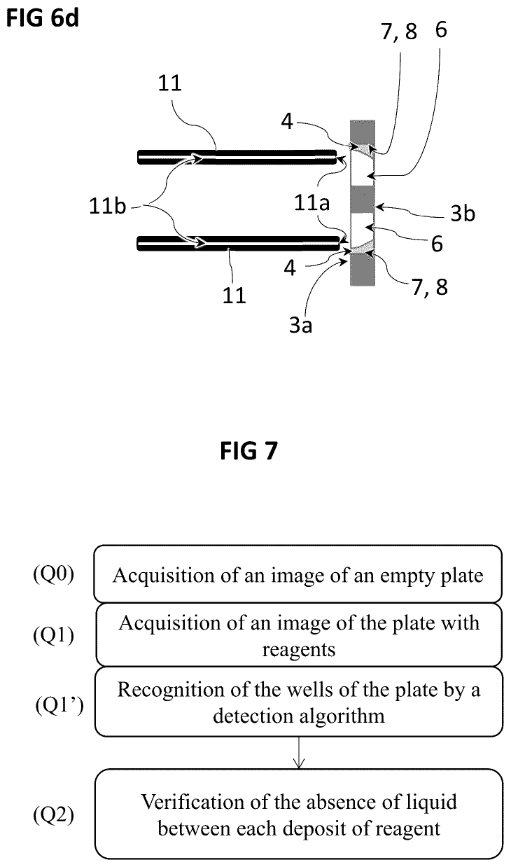

Then, in a step c), a liquid drop of reagent 4 is deposited in contact with the lateral surface 7 of the well 2. This step c) is depicted in FIGS. 6a to 6d, which show simultaneous deposition of two drops. Advantageously, each drop is deposited using a needle 11. Preferably, step c) of depositing a drop of reagent 4 comprises three sub-steps c1), c2) and c3), sub-step c1) being the placement of the needle 11, one end of the needle 11a being positioned just inside the internal space 6 of the well 2 as shown in FIG. 6a. Preferably, the end 11a of the needle does not protrude beyond the internal space 6. The end 11a of the needle therefore preferably passes through only one of the two faces 3a, 3b of the plate 3, and is thus preferably located between the first face 3a and the second face 3b. In FIG. 6a, for example, the end 11a of the needle only passes through the first face 3a.

Sub-step c2) corresponds to the formation of a drop of reagent 4 at the end 11a of the needle, by supplying a channel 11b of the needle with a reagent 4 in liquid form. A drop forms, and grows until it comes into contact with a wall 8 of the lateral surface 7 of a well 2, as shown in FIG. 6b. The position of the needle 11, and more specifically the distance of the end 11a of the needle from the lateral surface 7, dictates the size of the drop when it touches the wall. The end 11a of the needle is preferably offset relative to the center of the internal space 6, and is therefore closer to the part of the lateral surface 7 on which it is desired to deposit the drop of reagent 4, thus making it possible for the drops to be collected and retained in the lobes as soon as they form at the end 11a of the needles 11.

Each drop of reagent 4 formed typically has a diameter greater than 0.8 mm and, more preferably, a diameter greater than 1.2 mm. The diameter of each drop of reagent 4 is for example approximately equal to 1 mm. Once each drop comes into contact with the wall 8 of the lateral surface 7 of the well 2, it is deposited on the wall 8 as shown in FIG. 6c. Each drop of reagent 4 deposited preferably has a volume of less than 1 μL, more preferably, a volume of less than 0.65 μL. Preferably, the volume of each drop of reagent 4 deposited is greater than 0.1 μL and, more preferably, is greater than 0.35 μL. For example, each drop of reagent 4 has a volume approximately equal to 0.5 μL.

Once each drop has been deposited, each needle 11 or a plate support is withdrawn as per sub-step c3), out of the internal space 6 of the well 2 as shown in FIG. 6d. Next, again with reference to FIG. 5, in a step d), each drop of reagent 4 is dried such that dried reagent 4 is obtained on the wall 8 of the lateral surface 7 of the well 2. It will of course be understood that steps c) and d) of depositing a drop and drying are implemented on a plurality of wells 2 of the plate 3, preferably all of the wells 2 of the plate 3, simultaneously or sequentially.

In a certain embodiment according to which the wells 2 comprise several lobes 9, each lobe 9 of each well 2 is provided with at least one drop of reagent 4, and preferably with a single drop of reagent 4. Preferably, steps c) and d) of depositing a drop and drying are carried out simultaneously for each lobe 9 of several wells 2 of the plate 3, and preferably of each well 2. Thus, this drop deposition mode allows a plurality of drops to be deposited simultaneously in a microplate, in other words the plate 3. To be specific, using a support comprising a plurality of needles 11 and bringing this support up to a plate 3 such that each needle 11 has its end 11a in the internal space 6 of a well 2 of the plate 3, it is possible to simultaneously deposit drops of reagents 4 on a wall 8 of the lateral surface 7 of several wells 2. Furthermore, this method allows a plurality of drops to be deposited simultaneously on the walls 8 of each of the lobes 9 of each well 2 of a plate 3 without the drops mixing with one another in the same well 2. Consequently, tens, even hundreds of drops of reagents 4 with a volume of the order of a microliter may be deposited without human intervention in a short time. Taking the example of the analysis card 1 shown in FIG. 4 comprising thirty-five wells 2 with three lobes 9, the claimed production method may make it possible to simultaneously deposit a drop of reagent 4 on the wall 8 of each lobe 9 and therefore to simultaneously deposit 105 drops of reagents 4 in the plate 3 of the analysis card 1.

Preferably, the end 11a of a needle used for deposition is covered with a non-stick coating. For example, this coating may be a hydrophobic coating based on Teflon, such as polytetrafluoroethylene (PTFE). In this way, the drop which forms at the end of the needle 11a does not deform and does not flow along the needle 11, but on the contrary keeps a rounded shape allowing better control of the volumes deposited in the plate 3. Furthermore, in the case where several needles 11 are arranged side by side in a support, this allows the drops to avoid coming into contact and mixing, as shown in FIGS. 6a to 6d. In addition, the coating makes this solution more generic, allowing liquids with very varied surface tensions to be deposited.

Preferably, the present production method comprises a step e) of inserting the plate 3 between two films, preferably transparent films, and adhesion of the films to the plate 3 in such a way as to protect the reagents 4 and to close off the fluid network of the wells 2. The films form the ends of the closed wells 2 and are devoid of reagents 4.

### Quality Control Method

To ensure that the plate 3 has been provided with reagents 4 correctly, that is to say that each well 2 contains a drop of reagent 4 and that, in the case where the wells 2 comprise several lobes 9, the drops present in different lobes 9 of the same well 2 have not mixed, a method for quality control of a plate 3 is proposed before drying the reagents 4 (sub-step c3). More specifically, a method for quality control of a plate 3 provided with a plurality of wells 2 passing through said plate 3, each well 2 having a plurality of liquid reagents 4 deposited separately on its walls 8, is proposed. The method is described in FIG. 7.

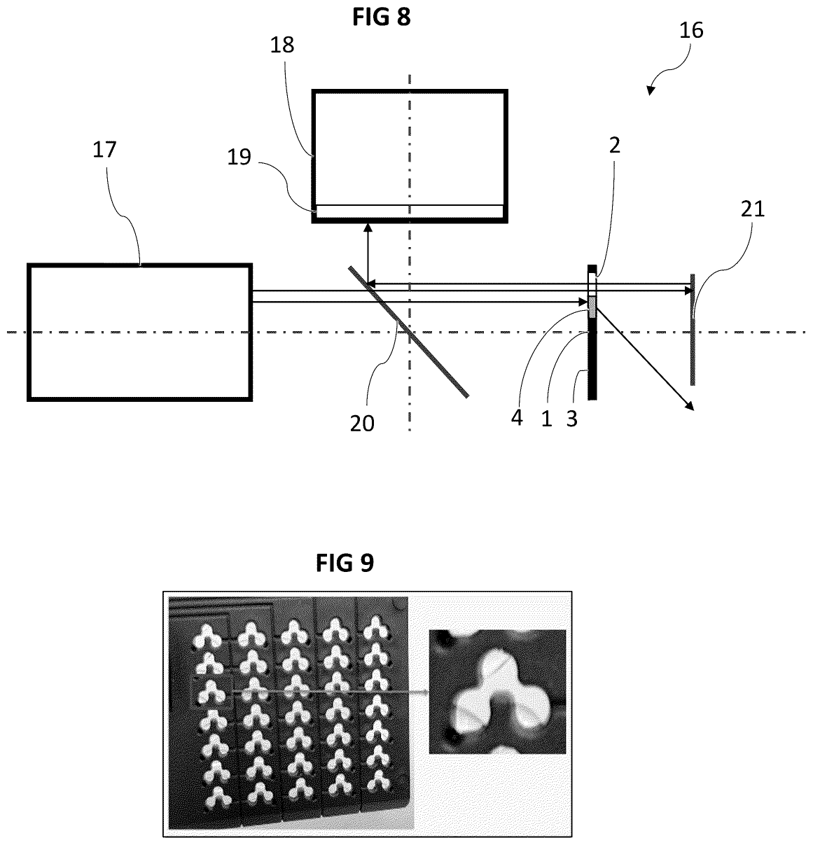

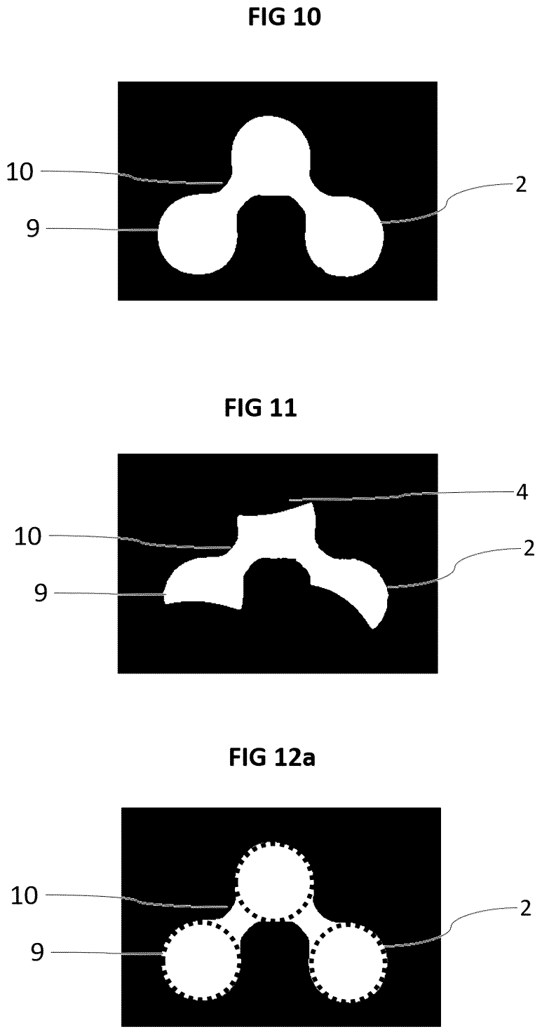

In a step Q1), an image of the plate 3 the wells 2 of which have a plurality of drops of liquid reagents 4 is acquired as shown in FIG. 9 or in FIG. 11. Preferably, the quality control method comprises a prior step Q0) of acquisition of an image of the empty plate 3, shown in FIG. 10. In other words, step Q0) consists of the acquisition of an image of the plate 3 when no reagent 4 has been deposited on the walls 8 of its wells 2. Advantageously, the images acquired in steps Q1) and Q0) of the quality control method are shadowgraphic images. With reference to FIG. 8, a shadowgraphic image may for example be acquired using a control system 16 comprising a light source 17 such as a telecentric lamp and an image acquisition device 18, for example provided with a telecentric lens 19. The plate 3 is positioned in its analysis orientation (typically with the faces 3a, 3b vertical) between the light source 17 and the image acquisition device 18. Coaxial rays of light are emitted by the light source 17 in the direction of the plate 3. These light rays pass through the internal spaces 6 of the wells 2 of the plate 3 or are absorbed by the faces 3a, 3b of the plate 3. The light rays which pass through the internal spaces 6 of the wells 2 are deflected by liquid reagents 4 present in the wells 2 or pass through the empty parts of the internal spaces 6 without deflection, if there are no liquid reagents 4 on their paths. The image acquisition device 18 only receives the light rays which are neither deflected nor absorbed by the faces 3a, 3b of the plate 3, that is to say the light rays having passed through an empty part of an internal space 6. By virtue of this control system 16, a black and white image of the plate 3 is obtained. The wells 2 are recognizable by their parts of empty internal space 6 which are white in the image. Still with reference to FIG. 8, the control system 16 may include mirrors 20, 21 which makes it possible to gain in compactness. For example, the control system 16 may include two mirrors 20, 21, namely a fully reflective mirror 21 and a semi-reflective mirror 20. The light rays emitted by the light source 17 pass through the semi-reflective mirror 20 then the plate 3 positioned in its analysis orientation. The undeflected or absorbed light rays reach the fully reflective mirror 21, which reflects said rays. These rays pass through the plate 3 again, until they reach the semi-reflective mirror 20, which reflects the rays toward the image acquisition device 18.

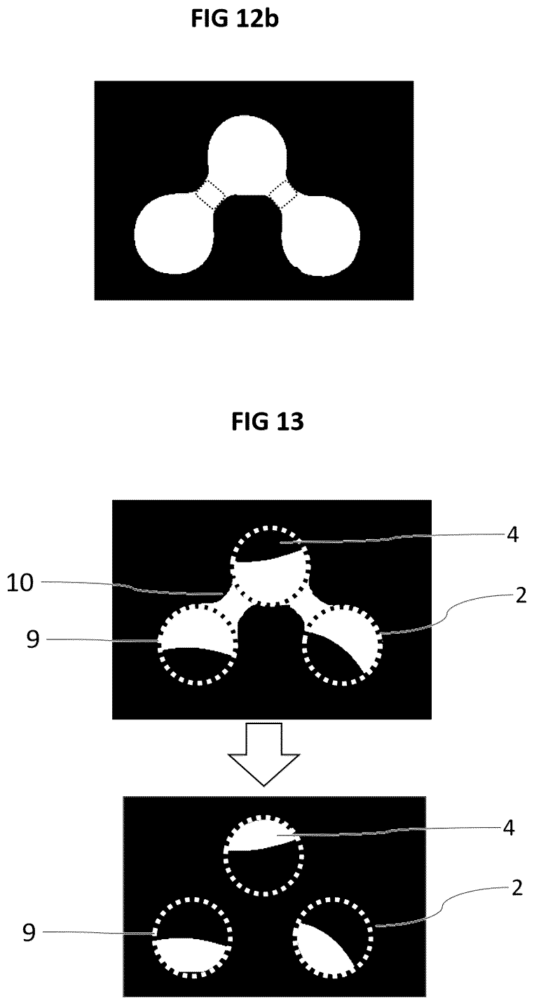

Furthermore, the quality control method preferably comprises a step Q1′) of recognition by an algorithm for detecting the wells 2 of the plate 3 and identification of regions of interest for each well 2 of the plate 3. Detection of wells 2 means that the wells 2 of the plate 3 are pinpointed in an acquired image. In the case where each well 2 comprises lobes 9 and junctions 10, detection may involve pinpointing lobes 9 and junctions 10. The well 2 detection algorithm may implement a detection function which depends on the known shape of the wells 2, adapted to the geometry of the wells 2 of the plate 3 and/or to a distribution of the wells 2 on the plate 3. For example, if it is desired to detect the lobes 9 and the lobes 9 have a circular shape, a circular rim detection function may be used, as shown in FIG. 12a.

Next, regions of interest are identified. Advantageously, at least one region of interest is identified for each well 2 of the plate 3. The identification of regions of interest may, for example, correspond to the identification of junctions 10 as shown in FIG. 12b. To be specific, in the case where it is desired to determine that the reagents 4 present in the different lobes 9 of a well 2 have not mixed, it can be verified that the junctions 10 are completely empty of reagent. Consequently, in this case, the junctions 10 constitute regions of interest. The regions of interest may also be the lobes 9, in particular in order to ensure the presence of reagents. It is of course possible to combine several approaches.

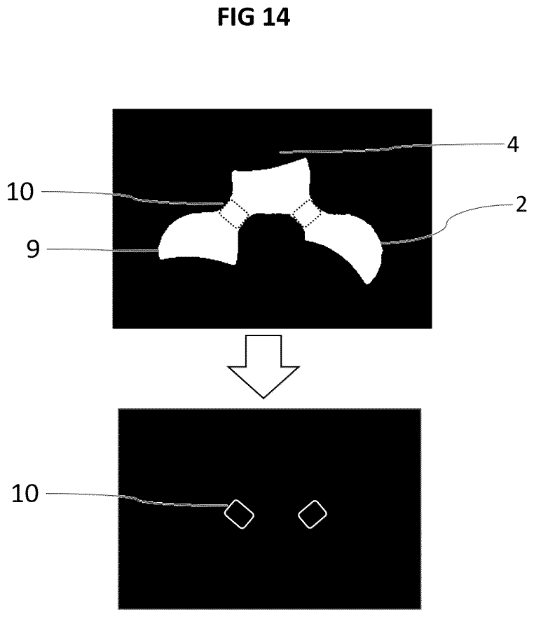

The quality control method therefore includes a step Q2) of verification of the absence of liquid between each deposit of liquid reagent 4. As explained, this may, for example, amount to verifying that no reagent 4 is present in the junctions 10 of a well 2. Preferably, this step Q2) comprises the comparison of pixels of the image acquired in step Q1) and of pixels of the image acquired in step Q0). It is also possible to make comparisons on groups of pixels. This comparison makes it possible to determine where the reagents 4 are present within a well 2 and, consequently, to identify an absence of reagents 4, a surplus of reagents 4 or the unwanted presence of reagents 4 in a certain part of a well 2. Preferably, comparing pixels means comparing their light intensity value and, more preferably, comparing their gray levels. Furthermore, preferably, each compared pixel of an image acquired in step Q1) is compared to the pixel located at the same location in the image acquired in step Q0). Advantageously, only the pixels corresponding to the regions of interest for each well are considered in the context of this comparison. To be specific, the regions of interest of the wells 2 of the plate 3 are the precise locations where it is desired to detect a presence or absence of reagent 4. For example, the regions of interest may be the junctions 10 of the wells 2 and it may be desired to detect whether reagent 4 is present in the junctions 10. This would probably mean that reagents 4 from two different lobes 9 of a well 2 have mixed. Furthermore, this comparison step Q2) may be likened to a subtraction of the two images. If pixels of the image of the plate 3 filled with reagents 4 acquired in step Q1) have a value different from the light intensity value of the same pixels of the image of the empty plate 3 acquired in step Q0), this may mean that a reagent 4 is present in the plate 3 at the position corresponding to said pixels, as shown in FIG. 13 for regions of interest at the lobes 9 and in FIG. 14 for regions of interest at the junctions 10. Threshold values for differences in light intensity values of pixels and in the number of pixels the light intensity value of which differs between the images acquired in steps Q1) and Q0) may be defined. Thus, starting from a certain number of pixels the light intensity value of which is different from a certain difference in light intensity value of pixels between the two images, it may be decreed that reagent 4 is present in the plate 3 at the position corresponding to said pixels. On the basis of the number of pixels which are identified as corresponding to spaces filled with reagent 4, a surface area of pixels corresponding to spaces filled with reagent 4 may be extracted. This surface area may be used and extrapolated so as to obtain an estimated volume of reagent 4 present in the wells 2 of the plate 3.

The invention is not limited to the embodiment described and shown in the appended figures. Modifications are possible, in particular from the point of view of the nature of the various technical features or of substitution of technical equivalents, without however departing from the scope of protection of the invention.

1. An analysis card for analysing a biological sample by means of an in vitro diagnostics instrument, the analysis card comprising a plurality of wells formed in a plate, wells containing at least one reagent, the analysis card comprising a supply channel for supplying a liquid sample to the well,
wherein each well forms in the plate an internal space defined by a lateral surface, the lateral surface comprising at least one wall, and wherein the reagent of a well is deposited and dried only on the lateral surface of the well,
wherein each well includes a plurality of lobes and a plurality of junctions connecting the lobes,
wherein each well has several different reagents deposited only on its lateral surface, the different reagents comprising a first reagent and a second reagent, and wherein a well contains at least the first reagent deposited on a wall of a first lobe of the well and the second reagent deposited on a wall of a second lobe of the well.

2. The analysis card as claimed in claim 1, wherein each well passes through the plate from one face to another face of the plate.

3. The analysis card as claimed in claim 1, wherein each well has several different reagents deposited on its lateral surface, the different reagents comprising a first reagent and a second reagent.

4. The analysis card as claimed in claim 3, wherein the second reagent is an activation agent for activating the first reagent and the activated first reagent is capable of reacting with the liquid sample when the activated first reagent is brought into contact with the liquid sample.

5. The analysis card as claimed in claim 1, wherein the lobes of a well have an elliptical shape and the junctions of a well are rectilinear in a junction direction.

6. The analysis card as claimed in claim 1, wherein a junction connects only two lobes of a well and all of the lobes and junctions of a well form an open chain.

7. The analysis card as claimed in claim 1, wherein the analysis card is associated with an analysis orientation imposed on the analysis card during the analysis of the biological sample by means of the in vitro diagnostics instrument, this analysis orientation being characterized by the faces of the plate extend in the predetermined direction, and wherein a first lobe of a well is connected to a second lobe of the well by a junction in a junction direction and the angle between the predetermined direction and the junction direction is greater than 10°.

8. The analysis card as claimed in claim 1, wherein the diameter of the lobes of the wells is greater than 0.1 mm, the width of the junctions is less than 1 mm, and the length of the junctions is greater than 0.05 mm.

9. The analysis card as claimed in claim 1, wherein each face of the plate is covered with a transparent film at least on a face intended to allow analysis of the analysis card.

10. The analysis card as claimed in claim 1, wherein the analysis reagents are adapted to cause a luminescence reaction in the presence of endotoxins.

11. A method for the production of an analysis card as claimed in claim 1, comprising the following steps:
a) supplying a plate provided with a plurality of wells,
b) positioning the plate in an analysis orientation in which the faces of the plate extend in the predetermined direction,
c) depositing at least one drop of reagent liquid in contact with a wall of the lateral surface of the well,
d) drying the at least one drop of reagent and obtaining reagent deposited on the wall of the lateral surface of the well.

12. The method as claimed in claim 11, comprising a step e) of inserting the plate between two films, and adhesion of the films to the plate.

13. The method as claimed in claim 11, wherein step c) of depositing the drop of reagent comprises steps of:
c1) placing a needle with one end of the needle in the internal space of a well,
c2) forming a drop at the end of the needle, until contact is made with a wall of the lateral surface,
c3) withdrawing the needle.

14. A method for quality control of a plate provided with a plurality of wells, each well forming in the plate an internal space defined by a lateral surface, wells having a plurality of deposits of liquid reagents deposited separately on the lateral surface thereof, comprising steps of:
Q1) acquisition of an image of the plate,
Q2) verification of the absence of liquid between deposits of liquid reagent.

15. The quality control method as claimed in claim 14, comprising a step Q0) of acquisition of an image of the empty plate, and step Q2) comprises the comparison of pixels of the image acquired in step Q1) and of pixels of the image acquired in step Q0).

16. The quality control method as claimed in claim 14, wherein the image of the plate is a shadowgraphy image.

17. The quality control method as claimed in claim 14, comprising a step a1) of recognition by an algorithm for detecting the wells of the plate and identification of regions of interest for each well of the plate for which the absence of liquid is verified.

18. The quality control method as claimed in claim 17, wherein each well comprises a plurality of lobes and a plurality of junctions connecting the lobes, the lobes being intended to receive the deposits of liquid reagents, and the regions of interest include the junctions, the absence of liquid in the junctions being verified.
